(19) United States
(12) Patent Application Publication
(10) Pub. No.: US 2025/0292165 A1
(43) Pub. Date: Sep. 18, 2025

(54) SYSTEM AND METHOD FOR ARTIFICIAL INTELLIGENCE GENERATED SUGGESTIONS FOR CORRECTIVE TRAINING ACTIONS

(71) Applicant: HSI USA Holding, Inc., Frisco, TX (US)

(72) Inventors: Jose Manuel William Arcilla, McKinney, TX (US); Michael Alan Case, Kennewick, WA (US); John William Hambelton, Eugene, OR (US)

(21) Appl. No.: 19/077,790

(22) Filed: Mar. 12, 2025

Related U.S. Application Data
(60) Provisional application No. 63/564,294, filed on Mar. 12, 2024.
(60) Provisional application No. 63/564,784, filed on Mar. 13, 2024.
(60) Provisional application No. 63/565,901, filed on Mar. 15, 2024.
(60) Provisional application No. 63/566,640, filed on Mar. 18, 2024.
(60) Provisional application No. 63/663,991, filed on Jun. 25, 2024.
(60) Provisional application No. 63/663,994, filed on Jun. 25, 2024.
(60) Provisional application No. 63/663,999, filed on Jun. 25, 2024.
(60) Provisional application No. 63/664,004, filed on Jun. 25, 2024.

(51) Int. Cl. G06Q 10/0631; G06F 16/34

(52) U.S. Cl. CPC G06Q 10/06311; G06F 16/345

(57) ABSTRACT

Systems, methods, and computer-readable storage media for using distinct Artificial Intelligence algorithms to review incident reports and identify, within a corpus of training courses, which courses would be best for mitigating or preventing future incidents. A system can receive an incident record involving an individual human being involved in an incident, then analyze that incident record by executing a first Artificial Intelligence (AI) algorithm, resulting in a natural language incident summary. The system can then generate, by executing a second AI algorithm using the natural language incident summary, corrective training recommendations for the individual human being, the corrective training recommendations predicted to perform at least one of mitigating or preventing the incident from occurring again, and provide those corrective training recommendations to an authority over the individual human being.

### CROSS-REFERENCE TO RELATED APPLICATIONS

The instant application is a U.S. Non-Provisional Application that claims priority to U.S. Provisional Application No. 63/564,294 filed Mar. 12, 2024, U.S. Provisional Application No. 63/564,784 filed Mar. 13, 2024, U.S. Provisional Application No. 63/565,901 filed Mar. 15, 2024, U.S. Provisional Application No. 63/566,640 filed Mar. 18, 2024, U.S. Provisional Application No. 63/663,994 filed Jun. 25, 2024, U.S. Provisional Application No. 63/663,991 filed Jun. 25, 2024, U.S. Provisional Application No. 63/663,999 filed Jun. 25, 2024 and U.S. Provisional Application No. 63/664,004 filed Jun. 25, 2024, the entire contents of each of which are hereby incorporated by reference in their entireties.

The present application is related to co-pending U.S. Application No. ______, Attorney Docket No. 131637.607931, filed Mar. 12, 2025, U.S. Application No. ______, U.S. Application No. ______, Attorney Docket No. 131637.607978, filed Mar. 12, 2025, and U.S. Application No. ______, Attorney Docket No. 131637.605724, filed Mar. 12, 2025, the entire contents of each of which are hereby incorporated by reference in their entireties.

### BACKGROUND

### 1. Technical Field

The present disclosure relates to identifying corrective training for individuals, and more specifically to using distinct Artificial Intelligence algorithms to review incident reports and identify, within a corpus of training courses, which courses would be best for mitigating or preventing future incidents.

### 2. Introduction

For organizations with a large catalog of available training courses, when incidents occur that require corrective training it can be challenging for the user responsible with determining the corrective action(s) to find the most appropriate training courses available to assign.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, an incident record involving an individual human being involved in an incident; analyzing, via at least one processor of the computer system executing a first Artificial Intelligence (AI) algorithm, the incident record, resulting in a natural language incident summary; generating, via the at least one processor executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

A system configured to perform the concepts disclosed herein can include: at least one processor; and a non-transitory computer-readable storage medium having instructions stored which, when executed by the at least one processor, cause the at least one processor to perform operations comprising: receiving an incident record involving an individual human being involved in an incident; analyzing, by executing a first Artificial Intelligence (AI) algorithm, the incident record, resulting in a natural language incident summary; generating, by executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

A non-transitory computer-readable storage medium configured as disclosed herein can have instructions stored which, when executed by at least one processor, cause the at least one processor to perform operations which include: receiving an incident record involving an individual human being involved in an incident; analyzing, by executing a first Artificial Intelligence (AI) algorithm, the incident record, resulting in a natural language incident summary; generating, by executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

### BRIEF DESCRIPTION OF THE DRAWINGS

FIG. 1 illustrates an example of a first AI algorithm generating a prompt based on a summary an incident record;

FIG. 2 illustrates an example of a second AI algorithm making corrective training course recommendations based on a prompt;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

When incidents occur in a workplace, corrective actions in the form of additional training may be taken in response to the incident. The goal of this additional training is to mitigate and/or prevent future incidents from taking place. For example, if an individual crashes a forklift, that individual may be required to take a remedial forklift training course. However, identifying what the appropriate training should be for a given incident can be a complicated problem. For example, for organizations with a large catalog of available training courses, it can also be challenging for the authority individual responsible with determining the corrective action(s) to find the most appropriate training courses available to assign and then track the progress of these assignments to completion. This problem can be even further exacerbated as the number of available courses increase.

The system disclosed herein utilizes a first AI algorithm to quickly analyze the details of an incident. The first AI algorithm can, for example, be and/or utilize a Large Language Model (LLM) to summarize details about the incident from an incident record (also known as an incident report). For example, the first AI algorithm may receive the incident record, then submit the incident record to the LLM with instructions such as “Summarize this report.” The LLM can then provide a natural language summary of the report. In configurations where the incident record contains sensitive or confidential information, the first AI algorithm can be trained to identify such sensitive/confidential information and not submit that information to the LLM. Alternatively, the first AI algorithm may be trained to remove any remaining sensitive/confidential information from the natural language summary provided by the LLM. In some configurations, the incident summary may not be in a natural language format, and instead the first AI algorithm can use the incident summary to generate a natural language prompt based on the incident summary.

Moreover, the system disclosed herein uses a distinct method of generating the prompt which is then provided to the LLM. Due to the configurable nature of the system, each client implementation may have data representing objects that vary wildly. The prompt generator has a template that defines the scenario, defines the output, and matches the parameters from a dataset using dynamic context from the associated metadata. This is turned into a standard prompt using natural language processing (NLP) that is then provided to the LLM, which in turn creates the summary.

Upon receiving the resulting natural language summary (or the natural language prompt) from the first AI algorithm, the system executes a second AI algorithm, the second AI algorithm having access to details of available training materials and training courses in the system, comparing the natural language summary of the incident (or prompt) against the available training materials/courses. Preferably, the second AI algorithm has access to all available training materials and training courses, though in some configurations the second AI algorithm may only have access to a portion of the available materials and training courses. Based on the natural language summary (or prompt) of the first AI algorithm and the available training courses (along with any additional inputs), the second AI algorithm can identify which of the available training courses have the highest likelihood to mitigate or prevent future incidents from occurring. For example, the second AI algorithm can rank all of the available training courses based on how likely those available training courses are to prevent or mitigate a future incident, then present the top ranked courses (e.g., the top five, or top ten) of those courses to an administrator or other authority. The authority can then select one or more of the training courses presented by the second AI algorithm and assign the individual that committed the incident to take the training.

The sequential application of distinct AI algorithms is unconventional with respect to corrective training for individuals, and more specifically to using distinct Artificial Intelligence algorithms to review incident reports and identify, within a corpus of training courses, which courses would be best for mitigating or preventing future incidents. Moreover, this sequential application provides increased accuracy while also mapping details about an incident to specific courses meant to address those details. In this system the AI algorithms together eliminate the need for maintaining a large traditional database of relations between keywords or phrases likely to be found in incidents to keywords or phrases found in an ever growing and evolving library of content.

The system disclosed herein can track the assigning, scheduling, and completion of training assigned from the moment the incident record is received. For example, when an incident occurs and the incident record received, the system can automatically create a requirement that one or more corrective actions must be taken. In many cases, these corrective actions will have a date assigned to them, where additional repercussions may occur if the corrective actions have not occurred by the assigned date.

Consider the following example. Jim was flagged by Human Resources for making an inappropriate joke. Upon receiving the incident record the first AI algorithm summarizes the incident record into a natural language incident summary. The system then executes a second AI algorithm (using the natural language incident summarization), which provides to Jim's supervisor (or other authority over Jim) a list of possible training courses such as: sexual harassment training, humor in the office training, and special needs training. The supervisor selects which of these courses Jim needs to take, and a deadline, and as Jim completes the selected training by the deadline the system can track both Jim's compliance and the approaching deadline. Both the compliance and deadline can be reported to the supervisor through the process.

The system can also contain a constant monitoring log, which stores the feedback, confidence scores, and other weighting factors, and constantly observes drift from established baselines to ensure responses are accurate. Using this data, the model can be iteratively refined such that the quality of recommendations improve to the point the AI can be granted permission to automatically assign its top recommendations, while still notifying supervisors of the action that has been taken or assigned. Systems can, for example, have a configurable threshold that would allow any recommendation that scores (generated using the feedback, confidence scores, and/or other weighting factors) above the threshold to be automatically assigned by the AI, only asking the supervisor for intervention when all recommendations fall below the threshold.

Consider another example. In this case, an Environmental, Health, Safety, and Quality (EHSQ) incident occurred. Upon analyzing the incident record, the summary of the first AI algorithm does not put the blame for the incident on a single individual, but rather assigns the error to number of people (e.g., an entire department or organization). The first AI algorithm generates a prompt (based on the summary) for use by the second AI algorithm to conduct a search of the catalog of available training courses. In this case, when the second AI algorithm is executed, a number of training courses are presented, the supervisor/authority selects one of the presented training courses, and all of the individuals identified are assigned to take the training. The system then tracks compliance of all of the individuals in taking and completing the assigned training.

Reducing the time and effort involved in determining and then executing the appropriate corrective actions, while ensuring their complete implementation in response to an identified risk, can save time and reduce operating costs as well as save workers from injury or death and/or prevent damage to workplace and company assets. While the ultimate responsibility for remediating individuals following an incident may remain with an authority/supervisor, the system disclosed herein can assist with this process by making automated recommendations. Alternatively, as discussed above, the system can make an automatic assignment based on certain predetermined thresholds being met, such that individuals associated with an incident may automatically be assigned to take training, complete tasks, or otherwise complete task to prevent future incidents.

In some cases, the assigned training can be reinforcement training (e.g., periodic revisiting/refreshing of course materials after an initial training is completed), with the goal of preventing future incidents. In other cases, the training can be follow-on training, where the assigned training is different than previous training, augmenting what was previously taught/learned.

The second AI algorithm can, in some configurations, use additional data beyond the details of available training materials and training courses in the system and the natural language summary of the incident in identifying recommended training courses. Non-limiting examples of additional data the second AI algorithm can use can include: the job title or level of the individual needing training; efficiency of a given training in reducing or mitigating future incidents (e.g., how often did incidents predicted to be prevented by the given training still occur?); data regarding the last time an individual received a given training; a training history of the individual human being(s) that need the training; and an incident record of the individual human being (e.g., how many incidents this particular individual has had); a previous exam performance on specific learning objectives; and/or time spent in online or in-person courses.

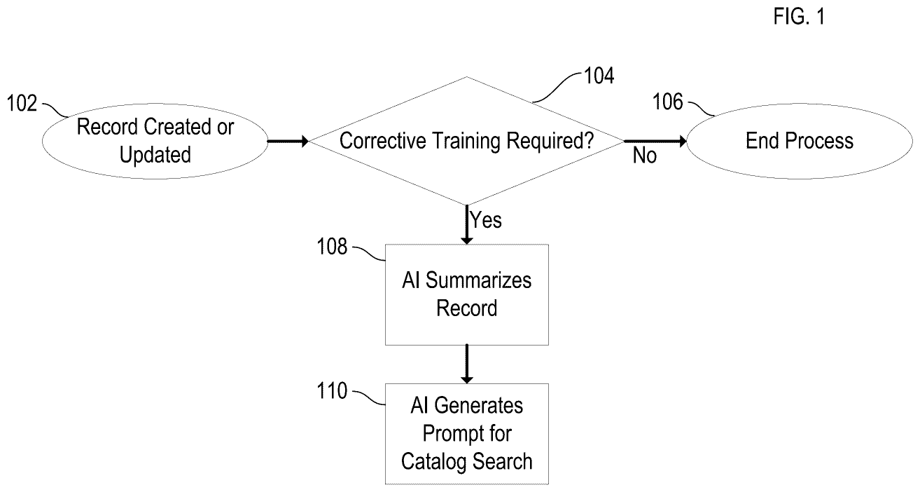

FIG. 1 illustrates an example of a first AI algorithm generating a prompt. The example of the first AI algorithm generating the prompt is a prompt for a catalog search. The example of the first AI algorithm generating the prompt can be based on a summary of an incident record. The system can also allow for corrective actions to be generated for nearly any record in the system, including hazards, unsafe events, or even pre-planned as part of an emergency response plan. As illustrated, a record, such as an incident record is created or updated 102, and the system can determine if corrective training is required 104. Preferably, the system can determine that corrective training is required before the AI becomes involved in the incident via a no-code workflow builder or through other determination mechanisms. This determination can, for example, be based on the type of incident recorded, the number of times the incident has been recorded (e.g., by an individual, across an organization, etc.), and/or how long it has been since a relevant training was completed by the individual or organization responsible. If no corrective training is required, then the process ends 106. If corrective training is required, then a first AI algorithm summarizes the record 108. AI summarization 108 is the result of a dynamic prompt which assembles many parameters of the system, record, and purpose of the summarization. This is all configurable and every implementation is different. For example, upon determining that an incident has occurred, the system will extract the purpose of the system based on the data associated with the incident (e.g., a EHSQ record keeping system for customer “ABC” in the “XYZ” industry, operating in locations “L” and “M”, etc.), language within the record (e.g., “this record represents a safety incident”, or similar language is found in the records), a schema for the data of the record (e.g., list of fields, their context, and their values), and/or a dynamic request of the summarization itself). This data, combined with a static definition of the format of the response, can then be provided to the LLM for summarization 108. The result of the AI summarization of the record 108 is an incident summary, preferably in a natural language format. Alternatively, if the response is going to be used in a machine-to-machine communication, an example of a non-natural language result can be a JSON (JavaScript Object Notation) file. Using this incident summary, the AI generates a prompt for a catalog search 110. In some configurations, the incident summary is provided to a LLM with instructions to generate a prompt for a catalog search (e.g., “Create instructions to search a catalog based on the following incident summary”).

As an alternative example, a prompt could be generated in the following manner. A record 102 could represent a forklift inspection. Instead of a summary of an incident, a summary of the inspection task (record 102) would be received by the system, and the system can ask the catalog what would be the considerations for a proper forklift inspection (rather than if corrective training is required 104 (step 104 being an evaluation stage)). The AI can then summarize the record 108, including the record 102 compared against the results of step 104. Such summarization 104 can further include context provided by the user(s) of the system. Other examples of records 102 can include: reported hazards, employee onboarding, safety checklists, new equipment use, etc.

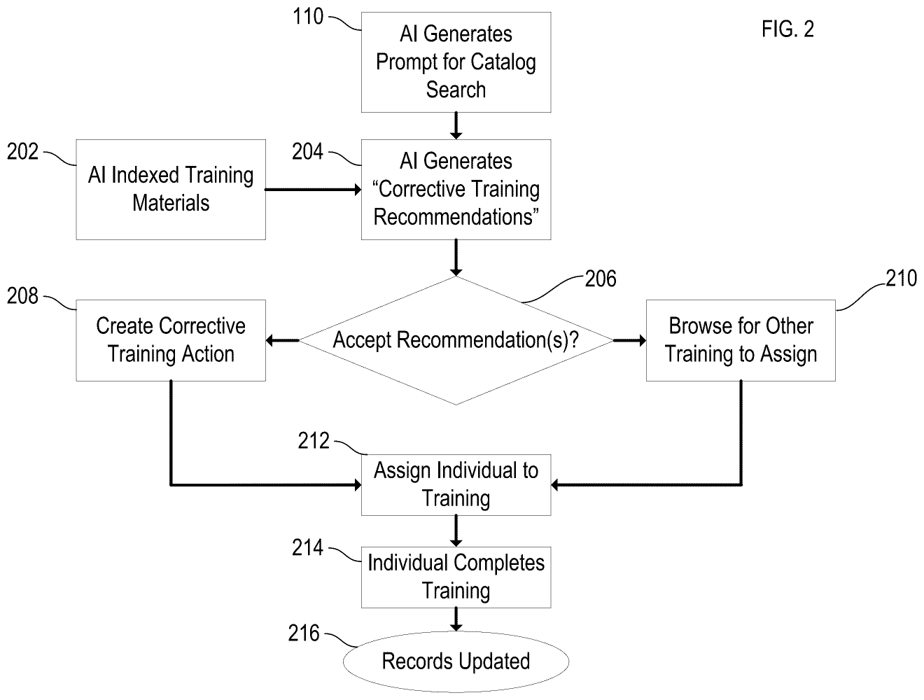

FIG. 2 illustrates an example of a second AI algorithm making corrective training course recommendations based on a prompt generated based on a summary of an incident record. In this case, the summary 108 described above is provided along with several other dynamic and static elements which dynamically generate a prompt 110 to an LLM.

As illustrated, following the steps illustrated in FIG. 1, the system executes a second AI algorithm 204 to generate corrective training recommendations. The second AI algorithm 204 uses AI indexed training materials 202 in identifying which training materials and/or training courses to recommend. The AI indexed training materials 202 itself is a large payload of provisioned and customer created knowledge that can address any subject, but is only limited to this procured information to keep the knowledge source high-quality. The recommendations are provided to a supervisor or other authority who can decide to accept the recommendations 206, browse for other training to assign 210, ask for additional recommendations, or ignore the recommendations. The expected output/recommendations generated by the AI can be three-fold: a list of course sources used to obtain the answer, a natural language response to the request, and/or a list of recommended training ranked by relevance, confidence, and human-derived priority meta-data. The recommendation can also include machine-to-machine calls to endpoints which generate lists of recommended training (e.g., lists of course identifications and course titles). These machine-to-machine calls can populate a user interface to assign training manual or automatically assign. The natural language results can be in the form of text describing the recommendations.

In some configurations, the system can automatically assign trainings based the incident summaries. For example, because the AI can output a response in a machine-readable payload to assign training, the system can take that payload and assign training automatically. This can, for example, be done if the response carries confidence and relevance scores above an configured threshold to avoid assigning training that does not meet the need. Once the training recommendation is selected, the system can create a corrective training action 208 (e.g., a requirement that the user complete the selected training), and assign the individual to training 212. The individual can then complete the training 214, and the records associated with the training can be updated 216. In some configurations, this record update, along with the predictions that resulted in the recommendations, can be stored and used for further training of the second AI algorithm, such that over time the second AI algorithm becomes more accurate in providing recommendations. For example, the system can contain a constant monitoring log which stores feedback, confidence scores, and other weighting factors. The system can then constantly observes drift from established baselines to ensure responses are accurate, while also improving accuracy over time.

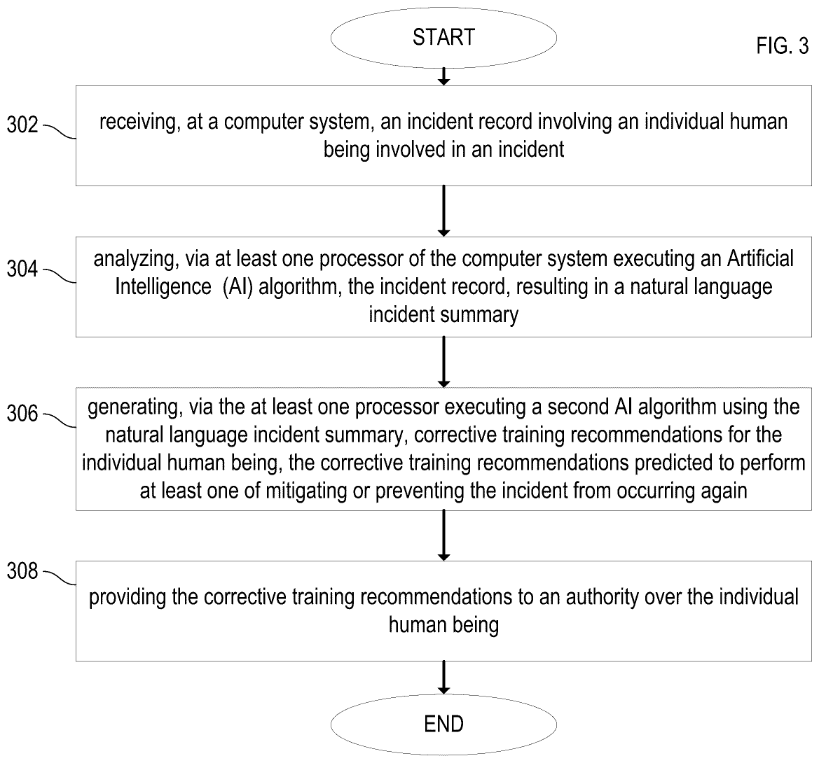

FIG. 3 illustrates an example method embodiment. As illustrated, the method can include: receiving, at a computer system, an incident record involving an individual human being involved in an incident (302), and analyzing, via at least one processor of the computer system executing a first Artificial Intelligence (AI) algorithm, the incident record, resulting in a natural language incident summary (304). The method continues by generating, via the at least one processor executing a second AI algorithm based on the natural language incident summary, corrective training recommendations for the individual human being, the corrective training recommendations predicted to perform at least one of mitigating or preventing the incident from occurring again (306), and providing the corrective training recommendations to an authority over the individual human being (308).

In some configurations, the incident is one or more of an environmental incident, a health incident, and a safety incident.

In some configurations, the incident is a quality control incident.

In some configurations, the first AI algorithm can include a Large Language Model (LLM).

In some configurations, the second AI algorithm can receive, as input: the natural language incident summary; a training history of the individual human being; and an incident record of the individual human being.

In some configurations, the second AI algorithm can use a database of training courses to identify the corrective training recommendations. In such configurations, the second AI algorithm can also use a plurality of incident records, and/or a plurality of training records to rank how training courses in the plurality of training courses are likely to perform the at least one of mitigating or preventing of the incident from occurring again, resulting in ranked training courses; and the corrective training recommendations represent at least one training course in the ranked training courses having a top ranking.

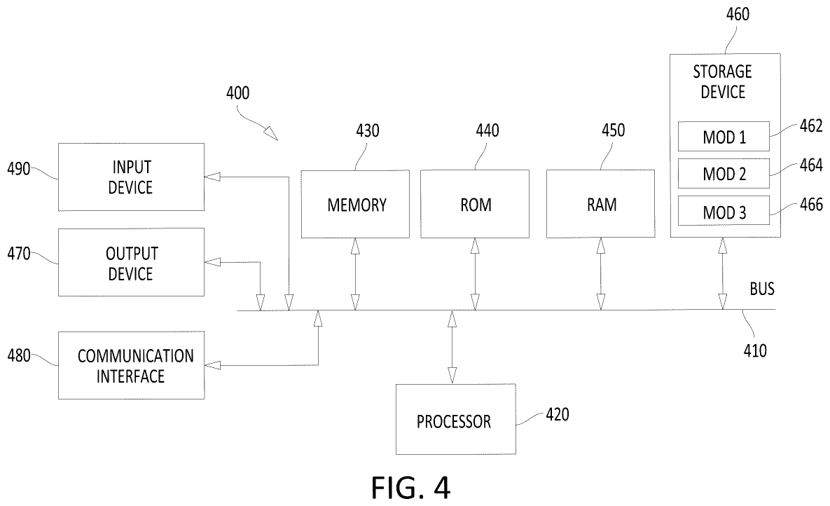

With reference to FIG. 4, an exemplary system includes a computing device 400 (such as a general-purpose computing device), including a processing unit (CPU or processor) 420 and a system bus 410 that couples various system components including the system memory 430 such as read-only memory (ROM) 440 and random access memory (RAM) 450 to the processor 420. The computing device 400 can include a cache of high-speed memory connected directly with, in close proximity to, or integrated as part of the processor 420. The computing device 400 copies data from the system memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The system memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in memory ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, system bus 410, output device 470 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 400 is a small, handheld computing device, a desktop computer, or a computer server.

Although the exemplary embodiment described herein employs the storage device 460 (such as a hard disk), other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, an incident record involving an individual human being involved in an incident; analyzing, via at least one processor of the computer system executing a first Artificial Intelligence (AI) algorithm, the incident record, resulting in a natural language incident summary; generating, via the at least one processor executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

The method of any preceding clause, wherein the incident is one of an environmental incident, a health incident, and a safety incident.

The method of any preceding clause, wherein the incident is a quality control incident.

The method of any preceding clause, wherein the first AI algorithm comprises a Large Language Model (LLM).

The method of any preceding clause, wherein the second AI algorithm receives, as input: the natural language incident summary; a training history of the individual human being; and an incident record of the individual human being.

The method of any preceding clause, wherein the second AI algorithm uses a database of training courses to identify the corrective training recommendations.

The method of any preceding clause, wherein: the second AI algorithm further uses the database of training courses, a plurality of incident records, and a plurality of training records to rank how training courses in the plurality of training courses are likely to perform the at least one of mitigating or preventing of the incident from occurring again, resulting in ranked training courses; and the corrective training recommendations represent at least one training course in the ranked training courses having a top ranking.

A system comprising: at least one processor; and a non-transitory computer-readable storage medium having instructions stored which, when executed by the at least one processor, cause the at least one processor to perform operations comprising: receiving an incident record involving an individual human being involved in an incident; analyzing, by executing a first Artificial Intelligence (AI) algorithm, the incident record, resulting in a natural language incident summary; generating, by executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

The system of any preceding clause, wherein the incident is one of an environmental incident, a health incident, and a safety incident.

The system of any preceding clause, wherein the incident is a quality control incident.

The system of any preceding clause, wherein the first AI algorithm comprises a Large Language Model (LLM).

The system of any preceding clause, wherein the second AI algorithm receives, as input: the natural language incident summary; a training history of the individual human being; and an incident record of the individual human being.

The system of any preceding clause, wherein the second AI algorithm uses a database of training courses to identify the corrective training recommendations.

The system of any preceding clause, wherein: the second AI algorithm further uses the database of training courses, a plurality of incident records, and a plurality of training records to rank how training courses in the plurality of training courses are likely to perform the at least one of mitigating or preventing of the incident from occurring again, resulting in ranked training courses; and the corrective training recommendations represent at least one training course in the ranked training courses having a top ranking.

A non-transitory computer-readable storage medium having instructions stored which, when executed by at least one processor, cause the at least one processor to perform operations comprising: receiving an incident record involving an individual human being involved in an incident; analyzing, by executing a first Artificial Intelligence (AI) algorithm, the incident record, resulting in a natural language incident summary; generating, by executing a second AI algorithm based on the natural language incident summary, corrective training recommendations for the individual human being, the corrective training recommendations predicted to perform at least one of mitigating or preventing the incident from occurring again; and providing the corrective training recommendations to an authority over the individual human being.

The non-transitory computer-readable storage medium of any preceding clause, wherein the incident is one of an environmental incident, a health incident, and a safety incident.

The non-transitory computer-readable storage medium of any preceding clause, wherein the incident is a quality control incident.

The non-transitory computer-readable storage medium of any preceding clause, wherein the first AI algorithm comprises a Large Language Model (LLM).

The non-transitory computer-readable storage medium of any preceding clause, wherein the second AI algorithm receives, as input: the natural language incident summary; a training history of the individual human being; and an incident record of the individual human being.

The non-transitory computer-readable storage medium of any preceding clause, wherein the second AI algorithm uses a database of training courses to identify the corrective training recommendations.

We claim:

1. A method comprising:
receiving, at a computer system, an incident record involving an individual human being involved in an incident;
analyzing, via at least one processor of the computer system executing a first Artificial Intelligence (AI) algorithm, the incident record, resulting in a natural language incident summary;
generating, via the at least one processor executing a second AI algorithm based on the natural language incident summary, corrective training recommendations for the individual human being, the corrective training recommendations predicted to perform at least one of mitigating or preventing the incident from occurring again; and
providing the corrective training recommendations to an authority over the individual human being.

2. The method of claim 1, wherein the incident is one of an environmental incident, a health incident, and a safety incident.

3. The method of claim 1, wherein the incident is a quality control incident.

4. The method of claim 1, wherein the first AI algorithm comprises a Large Language Model (LLM).

5. The method of claim 1, wherein the second AI algorithm receives, as input:
the natural language incident summary;
a training history of the individual human being; and
an incident record of the individual human being.

6. The method of claim 1, wherein the second AI algorithm uses a database of training courses to identify the corrective training recommendations.

7. The method of claim 6, wherein:
the second AI algorithm further uses the database of training courses, a plurality of incident records, and a plurality of training records to rank how training courses in the plurality of training courses are likely to perform the at least one of mitigating or preventing of the incident from occurring again, resulting in ranked training courses; and
the corrective training recommendations represent at least one training course in the ranked training courses having a top ranking.

8. A system comprising:
at least one processor; and
a non-transitory computer-readable storage medium having instructions stored which, when executed by the at least one processor, cause the at least one processor to perform operations comprising:
receiving an incident record involving an individual human being involved in an incident;
analyzing, by executing a first Artificial Intelligence (AI) algorithm, the incident record, resulting in a natural language incident summary;
generating, by executing a second AI algorithm based on the natural language incident summary, corrective training recommendations for the individual human being, the corrective training recommendations predicted to perform at least one of mitigating or preventing the incident from occurring again; and
providing the corrective training recommendations to an authority over the individual human being.

9. The system of claim 8, wherein the incident is one of an environmental incident, a health incident, and a safety incident.

10. The system of claim 8, wherein the incident is a quality control incident.

11. The system of claim 8, wherein the first AI algorithm comprises a Large Language Model (LLM).

12. The system of claim 8, wherein the second AI algorithm receives, as input:
the natural language incident summary;
a training history of the individual human being; and
an incident record of the individual human being.

13. The system of claim 8, wherein the second AI algorithm uses a database of training courses to identify the corrective training recommendations.

14. The system of claim 13, wherein:
the second AI algorithm further uses the database of training courses, a plurality of incident records, and a plurality of training records to rank how training courses in the plurality of training courses are likely to perform the at least one of mitigating or preventing of the incident from occurring again, resulting in ranked training courses; and
the corrective training recommendations represent at least one training course in the ranked training courses having a top ranking.

15. A non-transitory computer-readable storage medium having instructions stored which, when executed by at least one processor, cause the at least one processor to perform operations comprising:
receiving an incident record involving an individual human being involved in an incident;
analyzing, by executing a first Artificial Intelligence (AI) algorithm, the incident record, resulting in a natural language incident summary;
generating, by executing a second AI algorithm based on the natural language incident summary, corrective training recommendations for the individual human being, the corrective training recommendations predicted to perform at least one of mitigating or preventing the incident from occurring again; and
providing the corrective training recommendations to an authority over the individual human being.

16. The non-transitory computer-readable storage medium of claim 15, wherein the incident is one of an environmental incident, a health incident, and a safety incident.

17. The non-transitory computer-readable storage medium of claim 15, wherein the incident is a quality control incident.

18. The non-transitory computer-readable storage medium of claim 15, wherein the first AI algorithm comprises a Large Language Model (LLM).

19. The non-transitory computer-readable storage medium of claim 15, wherein the second AI algorithm receives, as input:
the natural language incident summary;
a training history of the individual human being; and
an incident record of the individual human being.

20. The non-transitory computer-readable storage medium of claim 15, wherein the second AI algorithm uses a database of training courses to identify the corrective training recommendations.
